(19) United States
(12) Patent Application Publication
(10) Pub. No.: US 2025/0351801 A1
(43) Pub. Date: Nov. 20, 2025

(54) Multi-Species Cervical Spine Extension

(71) Applicant: R&R LIVESTOCK EQUIPMENT LLC

(72) Inventor: Francisco Rempel, Honey Grove, TX (US)

(73) Assignee: R&R LIVESTOCK EQUIPMENT LLC, (US)

(21) Appl. No.: 18/669,372

(22) Filed: May 20, 2024

(51) Int. Cl. A61F 5/055; A61F 5/042

(52) U.S. Cl. CPC A01K 1/062; A01K 1/06; A01K 1/0606; A01K 1/0613

(57) ABSTRACT

Apparatus and associated methods relate to a cervical spine extender (CSE) having an adjustable separation distance between restraint members. In an illustrative example, the CSE may, for example, be selectively operable between at least an extended mode and a collapsed mode. The CSE may, for example, be coupled to a headgate. For example, when an animal is restrained in the headgate, the restraint members of the CSE may, for example, be disposed caudally to the head and rostrally to the headgate. The restraint members may, for example, be coupled to the headgate by extension arms. Various embodiments may advantageously permit adjustment of a separation distance to effectively accommodate operation with different sized animals.

### TECHNICAL FIELD

Various embodiments relate generally to animal handling.

### BACKGROUND

Animals may be handled to perform various procedures that improve, by way of example and not limitation, their health, welfare, and/or productivity. These procedures may include, for example: vaccination, deworming, tagging, castration, branding, and/or milking. Handling animals may, for example, permit inspection, diagnosis, treatment, and/or research of their conditions and/or behavior. Animal handling may require careful planning and execution to reduce stress and injury for both the animals and the handlers.

Different types of animals may have, for example, different characteristics, needs, and responses to handling. Some of the factors that affect animal handling may include, by way of example and not limitation: species, breed, sex, age, temperament, body condition, health status, previous experience, and/or social structure. For example, cattle are herd animals that may rely on visual and olfactory cues to communicate and follow a leader. Sheep are flock animals that may, for example, tend to move in groups and avoid isolation. Pigs are intelligent and curious animals that may, for example, be easily motivated by food rewards.

One of the tools that can facilitate animal handling is a headgate, which may be configured, for example, as a device that holds the head of an animal in a fixed position. A headgate may, for example, be used to restrain an animal for procedures such as, by way of example and not limitation, ear tagging, dehorning, and/or blood sampling. A headgate may, for example, be attached to a squeeze chute. A squeeze chute may be configured, for example, as a cage that applies pressure to the sides of an animal's body. A squeeze chute may, for example, be used to calm an animal and/or prevent it from kicking or moving during procedures such as, by way of example and not limitation, vaccination, castration, or branding. A squeeze chute may, by way of example and not limitation, be provided with a scale, a tilt table, and/or a palpation cage to perform additional functions.

### SUMMARY

Apparatus and associated methods relate to a cervical spine extender (CSE) having an adjustable separation distance between restraint members. In an illustrative example, the CSE may, for example, be selectively operable between at least an extended mode and a collapsed mode. The CSE may, for example, be coupled to a headgate. For example, when an animal is restrained in the headgate, the restraint members of the CSE may, for example, be disposed caudally to the head and rostrally to the headgate. The restraint members may, for example, be coupled to the headgate by extension arms. Various embodiments may advantageously permit adjustment of a separation distance to effectively accommodate operation with different sized animals.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary cervical spine extender (CSE) in a first, ‘narrowed’ configuration in an illustrative use-case scenario.

FIG. 2 depicts the exemplary CSE in a second, ‘widened’ configuration in an illustrative use-case scenario.

FIG. 3 depicts a CSE having multiple CSE actuators in an extended configuration, and FIG. 4 depicts the CSE of FIG. 3 in a collapsed configuration.

FIG. 5 depicts a CSE having a single CSE actuator in a collapsed configuration, and FIG. 6 depicts the CSE of FIG. 5 in an extended configuration.

FIG. 7 depicts illustrative CSE separation distance adjustment mechanisms.

Like reference symbols in the various drawings indicate like elements.

### DETAILED DESCRIPTION OF ILLUSTRATIVE EMBODIMENTS

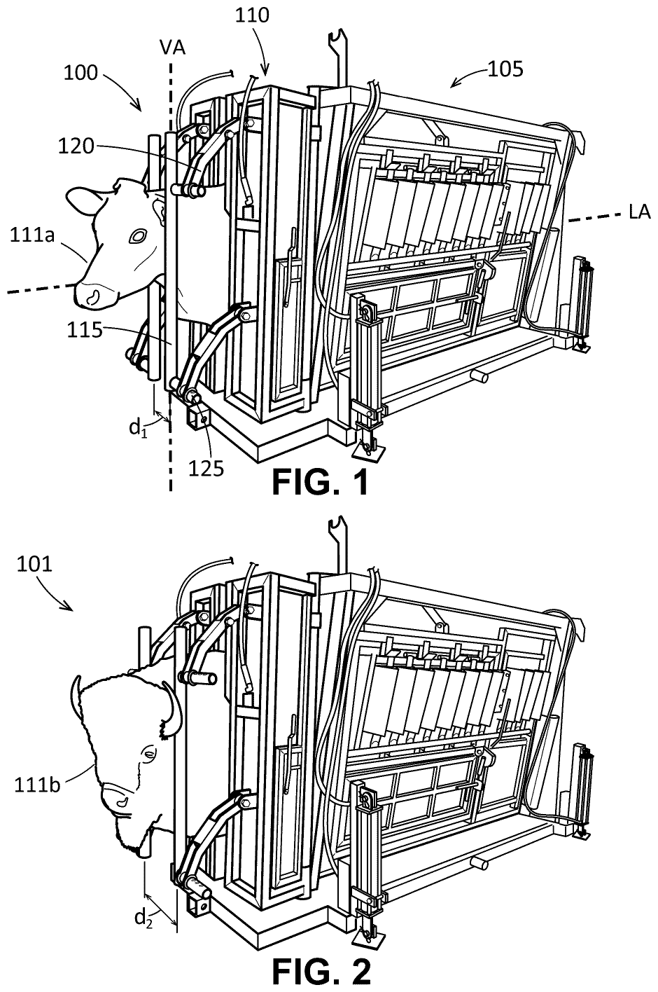

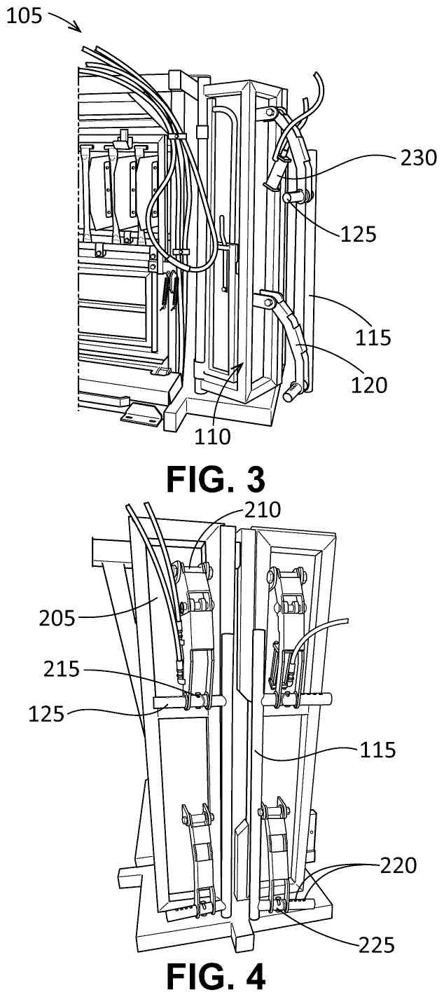

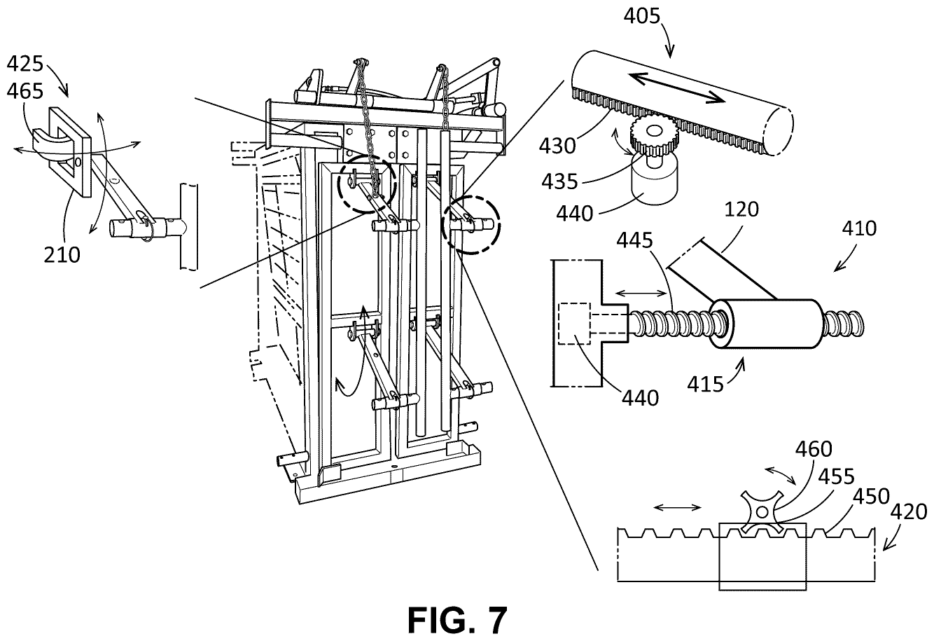

To aid understanding, this document is organized as follows. First, to help introduce discussion of various embodiments, a cervical spine extender (CSE) system is introduced with reference to FIGS. 1-2. Second, that introduction leads into a description with reference to FIGS. 3-6 of some exemplary embodiments of a CSE with various numbers of actuators. Third, with reference to FIG. 7, the discussion turns to exemplary embodiments that illustrate example mechanisms for adjusting a separation distance of a CSE. Finally, the document discusses further embodiments, exemplary applications and aspects relating to CSEs.

FIG. 1 depicts an exemplary cervical spine extender (CSE) in a first, ‘narrowed’ configuration in an illustrative use-case scenario. In the depicted example, a squeeze chute 105 is provided with a headgate 110. The headgate, as shown, is restraining an animal 111a (e.g., a cow, as depicted). The headgate 110 is provided with a CSE. As depicted, the CSE includes restraint members 115 (e.g., depicted as opposing restraint members). The restraint members 115 are mounted to the headgate 110 by extension members 120. The extension members 120 are shown in an extended mode such that the cervical spine (e.g., the neck) of the animal 111a is extended away from the headgate. The CSE may, for example, advantageously restrain the animal. The extension may, for example, advantageously provide access to the animal's neck (e.g., for treatment, injection).

As depicted, the restraint members 115 are separated from each other by a first distance d1 about a longitudinal axis (LA) of the animal. For example, each of the restraint members 115 may extend along a vertical axis (VA) when the headgate 110 is vertical. As shown, the restraint members 115 may, for example, each be provided with one or more width adjustment member 125. Accordingly, the separation distance between the restraint members 115 may, for example, advantageously be adjusted to accommodate a width of a neck of an animal being restrained.

For example, the extension members 120 are shown in FIG. 1 in a narrow mode 100. For example, the narrow mode 100 may be configured to accommodate the neck of the animal 111a. For example, a juvenile female bovine may have a relatively slender neck. A mature male bison may, for example, have a significantly wider (e.g., twice or more) neck.

FIG. 2 depicts the exemplary CSE in a second, ‘widened’ configuration in an illustrative use-case scenario. For example, a second animal 111b (e.g., a mature male bison) is being restrained in the headgate 110 and/or squeeze chute 105. As shown in FIG. 2, the CSE is operated into a widened configuration 101. In the depicted example, the restraint members 115 are adjusted away from each other to widen the separation distance to a separation distance d2, where d2>d1. For example, the widened configuration 101 may advantageously accommodate the wider neck of the second animal 111b.

FIG. 3 depicts a CSE having multiple CSE actuators in an extended configuration, and FIG. 4 depicts the CSE of FIG. 3 in a collapsed configuration. In this example, the extension members 120 are mounted to a headgate surface 205 of the headgate 110. For example, the extension members 120 may be releasably coupled (e.g., bolted, screwed, latched) to the headgate 110. For example, the extension members 120 may be welded to the headgate 110. For example, the extension members 120 may be mounted directly to the headgate surface 205 (e.g., as shown). In some examples, the extension members 120 may be mounted to another structure than the headgate (e.g., directly to the squeeze chute) and/or to an intermediary structure (e.g., a frame between the headgate and the CSE).

In this example, the extension members 120 is rotatably coupled. For example, as depicted, the extension members 120 is coupled to the headgate surface 205 by a proximal coupler 210. The proximal coupler 210 may, for example, be a hinge, as shown. For example, the proximal coupler 210 may be configured to pivotally couple the extension members 120 to the headgate 110. Accordingly, for example, the extension members 120 may be selectively rotatably operated between at least a collapsed mode (e.g., as shown in FIG. 4) and an extended mode (e.g., as shown in FIG. 3). In some implementations, the CSE may be operated into multiple extension stages (e.g., partially extended, fully extended). In some implementations, the CSE may be continuously operable between a stowage mode (e.g., in a collapsed configuration) and a deployed mode (e.g., fully extended configuration).

In this embodiment, each restraint member 115 is assembled (e.g., unitarily assembled, such as by welding) to two width adjustment members 125. In this example, each extension member 120 is provided with a distal coupler 215 (e.g., sleeve). Each width adjustment member 125 may, for example, be brought into register with and slidably coupled with the corresponding distal coupler 215.

As shown, the distal coupler 215 may include a sleeve with an aperture through the sleeve. In some implementations, the distal coupler 215 may include a latching mechanism. The distal coupler 215 may, for example, include a rib configured to engage a channel in the width adjustment member 125.

The width adjustment member 125 may be coupled into a target relationship such that a target separation distance (e.g., dn) is defined. For example, as shown, the width adjustment member 125 may be provided with a plurality of apertures 220. A target aperture of the plurality of apertures 220 may, for example, be brought into register with a corresponding coupling feature (e.g., corresponding aperture) in the distal coupler 215. An adjustment setting member 225 may, for example, be configured as a locking pin (as shown). The member 225 may, for example, be operated through the apertures in the distal coupler 215 and the selected aperture(s) in the plurality of apertures 220 such that the restraint member 115 is coupled into a fixed position. A similar operation may be followed for each of the restraint members 115 such that dn (separation distance) is defined.

In the depicted example, the CSE is provided with an actuator 230 for each of the extension members 120. For example, as shown, the actuator 230 may be a hydraulic actuator. In some implementations, the actuator may, for example, be manual. In some implementations, the actuator may, for example, be pneumatic. In some implementations, the actuator may, for example, be electric. The actuator may, for example, include a rack and pinion. The actuator may, for example, include a linear slide. The actuator may, for example, include a ball screw. The actuator may, for example, include an ACME threaded leadscrew.

The actuator 230 may, for example, be operated by a remote control (e.g., electric, hydraulic). For example, the actuators 230 may be simultaneously controlled by a single control. Accordingly, the actuators 230 may, for example, be advantageously operated simultaneously (e.g., in synchrony).

In some implementations, a multiple actuator embodiment of the CSE, such as shown in FIGS. 3-4, may advantageously increase extension force of the CSE. A multiple actuator embodiment of the CSE may, for example, advantageously provide a relatively direct force transfer to the extension arms. In some implementations, for example, a multiple actuator embodiment may be configured more compactly than other configurations. For example, the actuators may be disposed substantially within the extension arms (e.g., in a stowage mode, such as in the collapsed position shown in FIG. 4).

When the actuator 230 is operated (e.g., extended), the actuator 230 may cause the extension members 120 to be operated (e.g., extended). In the depicted example, the actuator 230 is configured such that, when the actuator 230 is extended, the extension member 120 rotates about the proximal coupler 210. As the extension member 120 extends, the extension member 120 rotations about the width adjustment member 125, effectively extending the restraint member 115 away from the headgate 110.

In some implementations, the actuator 230 may cause the extension member 120 to linearly extend (e.g., vs and/or in addition to rotating). The actuator 230 may, for example, cause the extension member 120 to pivot side to side.

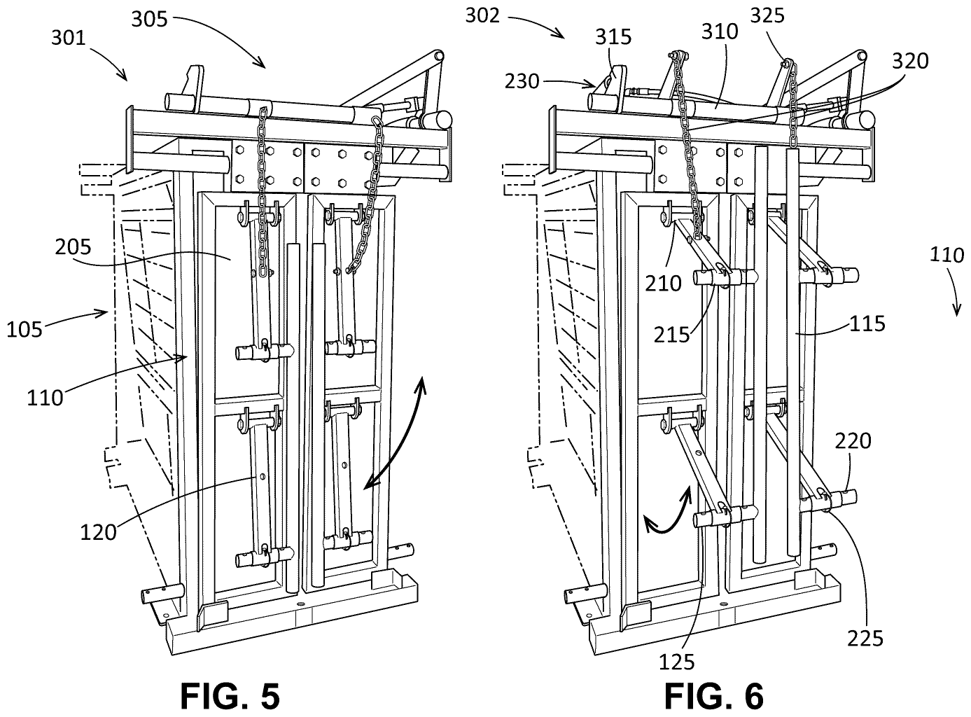

FIG. 5 depicts a CSE having a single CSE actuator in a collapsed configuration, and FIG. 6 depicts the CSE of FIG. 5 in an extended configuration. As shown, the CSE may be operated, for example, between a stowage mode 301 (in the collapsed configuration) and the extension mode 302 (in the extended configuration). Further, as discussed previously, the restraint members 115 are operable to create a variable separation distance, with a narrower separation distance shown in FIG. 5 and a wider separation distance shown in FIG. 6.

In the depicted example, the single-actuator CSE 305 includes a single actuator 230 configured to operate both the restraint members 115 via a linkage assembly. For example, a single actuator embodiment may advantageously reduce manufacturing costs (e.g., component costs, assembly costs). A single actuator embodiment may, for example, advantageously reduce maintenance time and/or costs (e.g., by having less components to repair). In some implementations, a single actuator embodiment may advantageously permit the actuator to be relocated such that the CSE requires a smaller envelope in front of the headgate than may be required, for example, with multiple and/or direct-actuation actuators.

In the depicted example in FIGS. 5-6, the linkage assembly includes a drive member 310 rotatably coupled to a fixed structure (e.g., a frame of the headgate 110, as shown). The drive member 310 is coupled to the actuator 230 via a lever 315. The actuator 230 is attached (e.g., rotatably) to a first end of the lever 315 and the opposing end of the lever 315 is attached (e.g., fixedly) to the drive member 310. Accordingly, actuation of the actuator 230 (e.g., linear extension/retraction) rotates the drive member 310 about a longitudinal axis of the drive member 310.

The drive member 310 is coupled (e.g., mechanically) to selectively extend and retract the restraint members 115 via the extension members 120. For example, as shown, the drive member 310 is coupled to the proximal coupler 210 via drive links 320.

The drive links 320 may, for example, be chains (as shown). In some implementations, the drive links 320 may, for example, be cables. In some implementations, the drive links 320 may, for example, be rods. For example, rods may advantageously apply tensile and/or compressive forces.

In the depicted example, the drive links 320, are coupled to the drive member 310 by one or more lever 325. Rotation of the drive member 310 may, for example, rotate the one or more lever 325 such that the drive links 320 are lifted and/or lowered. Lifting and/or lowering of the drive links 320 may, for example, lift and/or lower, respectively, the coupled extension members 120. Lifting and/or lowering of the extension members 120 may, for example, advantageously extend or retract (e.g., respectively, in the depicted example) the restraint members 115.

FIG. 7 depicts illustrative CSE separation distance adjustment mechanisms. For example, some embodiments may include a separation distance adjustment drive 405. The adjustment drive 405 may, for example, be configured as a rack and pinion drive. The rack 430 may, for example, be disposed on one or more of width adjustment member 125. A pinion 435 may, for example, be disposed in and/or about the CSE and configured to drive the rack 430. For example, the pinion 435 may be disposed in/about the distal coupler 215. For example, the pinion 435 may be disposed in/about the extension member 120. In the depicted example, the pinion 435 is coupled to an actuator (e.g., rotary actuator) 440. For example, the actuator 440 may include a motor (e.g., electric). For example, the actuator 440 may include a hydraulic actuator. The actuator 440 may, for example, be selectively operated (e.g., from a control interface by a user and/or automatic control system) to selectively widen or narrow the separation distance between the restraint members 115.

Some embodiments may, for example, include an adjustment drive 410. The adjustment drive 410 may, for example, be configured as an inclined plane drive. For example, as shown, the adjustment drive 410 may include a threaded drive member 445. The threaded drive member 445 may, for example, be rotated relative to a threaded socket 415. Rotation of the threaded drive member 445 relative to the threaded socket 415 may, for example, advance/retract the corresponding (e.g., attached) restraint member 115.

The threaded drive member 445 may, for example, be a ball screw. The threaded drive member 445 may, for example, be a leadscrew. For example, the threaded drive member 445 may include a threaded rod (e.g., ACME threaded, UNC threaded).

In some examples, the threaded drive member 445 and/or the rack 430 may, for example, be driven by a worm gear (not shown). For example, the pinion 435 may be configured as a worm gear. The actuator 440 may be re-oriented to drive the worm gear. Such embodiments may, for example, advantageously provide more controlled response speed (e.g., slower) and/or higher linear force applied relative to motor torque and/or power.

As an illustrative example, the threaded drive member 445 may be coupled to be driven (e.g., rotated) by an actuator 440 (e.g., as shown in FIG. 7). The actuator 440 may, for example, be disposed in a restraint member 115. In some implementations, the element indicated as actuator 440 may, for example, be an anchor (e.g., without a motor).

In some implementations, such as shown, the distal coupler 215 may, for example, be configured as the threaded socket 415. In some examples, the threaded socket 415 may, for example, include a drive mechanism. For example, a rotating collar may be disposed in threaded socket 415. The rotating collar may, for example, drive the threaded drive member 445 (e.g., instead of or in addition to the actuator 440).

Some embodiments may include, for example, an adjustment mechanism 420. The adjustment mechanism 420 may, for example, be configured as a ratcheting mechanism. For example, in some implementations the width adjustment member 125 may be provide with catchment members 450 (e.g., ratchet ‘teeth’). The catchment members 450 may, for example, be assembled onto the surface (e.g., of the width adjustment member 125). The catchment members 450 may, for example, be formed into (e.g., cut, molded, cast) the surface.

A channel 455 may, for example, be configured to register with the catchment members 450. For example, the distal coupler 215 may be configured as a channel 455. A selector 460 may, for example, be provided. The selector 460 may, for example, be coupled to the channel 455. The selector 460 may, for example, be configured as a ratchet ‘pawl.’ The selector 460 may, for example, as shown, be configured to selectively engage the catchment members 450 in at least one direction. For example, as shown, the selector 460 may advantageously lock the catchment members 450 in position relative to the channel 455 by resisting linear motion in either direction. If rotated to the left, the selector 460 may advantageously resist movement of the catchment members 450 in a first direction (e.g., to the right), but permit movement of the catchment members 450 in a second (opposite) direction (e.g., to the left), such as by ‘popping’ over the catchment members 450. If rotated to the right, the selector 460 may advantageously resist movement in the second direction but permit movement in the first direction. For example, the selector 460 may be biased (e.g., spring-loaded) into a position. The selector 460 may be operated (e.g., by a user) into one or more biased configurations (e.g., as shown, rotated to the left, rotated to the right) to remain in the selected position.

Some embodiments may, for example, include a side-pivoting arm 425. For example, the extension member 120 may be configured as a side-pivoting arm 425. As an illustrative example, the extension member 120 may be mounted to the headgate 110 by a side-pivoting and/or a vertical pivoting mechanism. In the depicted embodiment, by way of example and not limitation, the extension member 120 is provided with a hooked terminus 465. The hooked terminus 465 is configured to engage (e.g., couple to) a proximal coupler 210 configured to permit rotation. For example, the proximal coupler 210 and the hooked terminus 465 may be configured to permit pivoting of the extension member 120 side to side. For example, the proximal coupler 210 and the hooked terminus 465 may be configured to permit pivoting of the extension member 120 up and down. Some embodiments may, for example, advantageously permit the separation distance to be adjusted by pivoting of the extension members 120.

Although various embodiments have been described with reference to the figures, other embodiments are possible. For example, in some implementations, the restraint members 115 may be vertical (e.g., when the headgate 110 is upright). The restraint members 115 may, for example, be opposing restraint members, such as shown in FIGS. 1-7. In some implementations, the restraint members 115 may be opposing along intersecting lines (e.g., non-parallel). In some implementations, the restraint members 115 may be out of vertical. For example, in some implementations, the restraint members 115 may be configured as a “V.” For example, in some implementations, the restraint members 115 may be configured as upper and lower (e.g., instead of or in addition to side-to-side). In some implementations, a single member (e.g., a “U” shape) may be used for both restraint members. For example, a flexible joint in the single member may allow an adjustment of a separation distance.

For example, some embodiments may be provided with one or more sensor(s). The sensor(s) may, for example, include optical sensors. The sensor(s) may, for example, include pressure sensors. The sensor(s) may, for example, include proximity sensors. For example, the sensor(s) may be coupled to a control system. The control system may, for example, be configured to operate in response to the sensors. For example, the control system may control an amount of extension based on a pressure threshold (e.g., applied to the animal, such as measured by strain and/or force and/or pressure).

For example, the control system may control a separation distance. The distance may, for example, be controlled based on a width of an animal's neck. The distance may, for example, be controlled based on a proximity and/or distance of the restraint members 115 to the animal's neck. The separation distance may, for example, be controlled based on a pressure applied by the restraint members 115 to the animal.

Actuators (e.g., actuator 440, actuator 230, other actuator(s)) may, for example, be electric. For example, an actuator may include a hydraulic actuator (e.g., a hydraulic piston). In some implementations, an actuator may, for example, be pneumatic (e.g., pneumatic piston). In some implementations, an actuator may, for example, be electric (e.g., electric motor). An actuator may, for example, include a rack and pinion. The actuator may, for example, include a linear slide. An actuator may, for example, include a ball screw. An actuator may, for example, include an ACME threaded leadscrew.

An actuator may, for example, be operated by a remote control (e.g., electric, hydraulic). For example, actuators may be simultaneously controlled by a single control. Accordingly, actuators may, for example, be advantageously operated simultaneously (e.g., in synchrony).

In some implementations, an actuator may, for example, be manual. For example, an actuator may include a crank. An actuator may, for example, include a slide. An actuator may, for example, include a cam. An actuator may, for example, include a lever.

Although an exemplary system has been described with reference to the figures, other implementations may be deployed in other industrial, scientific, medical, commercial, and/or residential applications. For example, other embodiments may be configured for smaller animals. Some embodiments may, for example, be configured for goats and/or sheep. Some embodiments may, for example, be configured for pigs. Some embodiments may, for example, be configured for alpacas and/or llamas. Some embodiments may, for example, be configured for equines.

For example, in some implementations, a CSE may be configured for a fitting stand. In some implementations, a CSE may be configured for a set of stocks (e.g., such as used for equines). In some implementations, a CSE may be configured for a set of scales. In some implementations, a CSE may be configured for a stanchion. Various embodiments may include a kit including one or more pieces of equipment, such as disclosed in this paragraph and/or the Background as part of the CSE.

Some embodiments may, for example, be configured for companion animal use. Some embodiments may, for example, be configured for dogs. Some embodiments may, for example, be configured for cats. For example, some embodiments may be configured for veterinary surgery. In some implementations, embodiments may be configured for grooming.

Some embodiments may, for example, be configured for exotics. For example, some embodiments may be configured for deer and/or other prey animal exotics. For example, some embodiments may be configured for elephants. Some implementations may, for example, be configured for giraffes. Some embodiments may, for example, be configured for predator animal exotics (e.g., wild cats).

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Temporary auxiliary energy inputs may be received, for example, from chargeable or single use batteries, which may enable use in portable or remote applications. Some embodiments may operate with other DC voltage sources, such as a 12V (nominal) battery, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In an illustrative aspect, a multi-species cervical spine extender may include a headgate configured to selectively restrain an animal between a head and shoulders of the animal such that the animal is restrained from traveling along a longitudinal axis and a cervical spine extender (CSE) selectively operable between at least an extended mode and a collapsed mode. The CSE may include, for example, opposing restraint members including parallel bars configured such that, when the headgate restrains the animal, the parallel bars are disposed caudally to the head and rostrally to the headgate. The CSE may include, for example, extension arms coupled to the opposing restraint members and the headgate such that a separation distance between the parallel bars about the longitudinal axis is adjustable.

In an illustrative aspect, a multi-species cervical spine extender may include a headgate configured to selectively restrain an animal between a head and shoulders of the animal such that the animal is restrained from traveling along a longitudinal axis and a cervical spine extender (CSE) selectively operable between at least an extended mode and a collapsed mode. The CSE may include, for example, restraint members configured such that, when the headgate restrains the animal, the restraint members are disposed caudally to the head and rostrally to the headgate on opposing sides of a neck of the animal. The CSE may include, for example, extension arms coupled to the restraint members and the headgate such that a separation distance between the restraint members about the longitudinal axis is adjustable.

The restraint members may include, for example, parallel bars. The parallel bars may, for example, be vertically oriented when the headgate is oriented to restrain the animal in a standing position.

The extension arms of the CSE may, for example, be rotatably coupled to the headgate. The extension arms may, for example, be rotatably coupled to the restraint members.

The extension arms may include, for example, multiple extensions arms for each of the restraint members.

The CSE may include, for example, an actuator configured to selectively operate the cervical spine extender between at least the extended mode and the collapsed mode. The actuator may include, for example, a single actuator. The single actuator may, for example, be mechanically coupled to simultaneously operate the restraint members. The single actuator may, for example, be coupled to a shaft by a first lever arm. The restraint members may, for example, be coupled to the shaft by at least a second lever arm. The single actuator may, for example, be configured to rotate the shaft by the first lever arm such that the restraint members are extended and/or retracted by the at least a second lever arm. The restraint members may, for example, be each coupled to the single actuator by a corresponding extension arm of the extension arms.

The actuator may include, for example, a first actuator configured to operate a first of the restraint members. The actuator may include, for example, a second actuator configured to operate a second of the restraint members.

The actuator may include, for example, a hydraulic cylinder.

The restraint members may, for example, protrude inwards towards each other from a pivoting mechanism connecting the restraint members to the headgate, such that the restraint members hold the head of the animal away from the pivoting mechanism.

The separation distance may, for example, be adjustable by alignment of predetermined apertures in the restraint members and the extension arms. The separation distance may, for example, be manually adjustable.

The CSE may include, for example, a squeeze chute coupled to the headgate. The squeeze chute may, for example, be hydraulically actuated. The squeeze chute may, for example, be a tilt-over squeeze chute.

The CSE may include, for example, a tub and/or alley operably coupled to the squeeze chute.

In an illustrative aspect, a multi-species cervical spine extender may include, for example, a headgate configured to selectively restrain an animal between a head and shoulders of the animal such that the animal is restrained from traveling along a longitudinal axis. The CSE may, for example, include mechanisms described herein configured to extend a cervical spine of the animal and selectively operable between at least an extended mode and a collapsed mode and defining a separation distance about the longitudinal axis sufficient to receive a neck of the animal and less than a width of the head and a width of the shoulders of the animal such that, when the headgate restrains the animal, the separation distance is adjustable.

In some implementations, the CSE of any of [0056], [0057], and [0061] may be configured according to any embodiment of [0056]-[0068], singly or in combination.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A multi-species cervical spine extender comprising:
a headgate configured to selectively restrain an animal between a head and shoulders of the animal such that the animal is restrained from traveling along a longitudinal axis; and,
a cervical spine extender selectively operable between at least an extended mode and a collapsed mode, the cervical spine extender comprising:
opposing restraint members comprising parallel bars configured such that, when the headgate restrains the animal, the parallel bars are disposed caudally to the head and rostrally to the headgate; and,
extension arms coupled to the opposing restraint members and the headgate such that a separation distance between the parallel bars about the longitudinal axis is selectively adjustable relative to a position of the headgate.

2. A multi-species cervical spine extender comprising:
a headgate configured to selectively restrain an animal between a head and shoulders of the animal such that the animal is restrained from traveling along a longitudinal axis; and,
a cervical spine extender selectively operable between at least an extended mode and a collapsed mode, the cervical spine extender comprising:
restraint members configured such that, when the headgate restrains the animal, the restraint members are disposed caudally to the head and rostrally to the headgate on opposing sides of a neck of the animal; and,
extension arms coupled to the restraint members and the headgate such that a separation distance between the restraint members about the longitudinal axis is selectively adjustable relative to a position of the headgate.

3. The spine extender of claim 2, wherein the restraint members comprise parallel bars, and the parallel bars are vertically oriented when the headgate is oriented to restrain the animal in a standing position.

4. The spine extender of claim 2, wherein the extension arms are rotatably coupled to the headgate.

5. The spine extender of claim 2, wherein the extension arms are rotatably coupled to the restraint members.

6. The spine extender of claim 2, wherein the extension arms comprise a plurality of extensions arms for each of the restraint members.

7. The spine extender of claim 2, further comprising an actuator configured to selectively operate the cervical spine extender between at least the extended mode and the collapsed mode.

8. The spine extender of claim 7, wherein the actuator comprises a single actuator, and the single actuator is mechanically coupled to simultaneously operate the restraint members.

9. The spine extender of claim 8, wherein the single actuator is coupled to a shaft by a first lever arm, and the restraint members are coupled to the shaft by at least a second lever arm, and the single actuator is configured to rotate the shaft by the first lever arm such that the restraint members are extended and/or retracted by the at least a second lever arm.

10. The spine extender of claim 8, wherein the restraint members are each coupled to the single actuator by a corresponding extension arm of the extension arms.

11. The spine extender of claim 7, wherein the actuator comprises:
a first actuator configured to operate a first of the restraint members; and,
a second actuator configured to operate a second of the restraint members.

12. The spine extender of claim 7, wherein the actuator comprises a hydraulic cylinder.

13. The spine extender of claim 7, wherein the restraint members protrude inwards towards each other from a pivoting mechanism connecting the restraint members to the headgate, such that the restraint members hold the head of the animal away from the pivoting mechanism.

14. The spine extender of claim 2, wherein the separation distance is adjustable by alignment of predetermined apertures in the restraint members and the extension arms.

15. The spine extender of claim 2, wherein the separation distance is manually adjustable.

16. The spine extender of claim 2, further comprising a squeeze chute coupled to the headgate.

17. The spine extender of claim 16, wherein the squeeze chute is hydraulically actuated.

18. The spine extender of claim 17, wherein the squeeze chute is a tilt-over squeeze chute.

19. The spine extender of claim 18, further comprising a tub and alley operably coupled to the squeeze chute.

20. A multi-species cervical spine extender comprising:
a headgate configured to selectively restrain an animal between a head and shoulders of the animal such that the animal is restrained from traveling along a longitudinal axis; and,
means for extending a cervical spine of the animal, the means for extending the cervical spine selectively operable between at least an extended mode and a collapsed mode and defining a separation distance about the longitudinal axis sufficient to receive a neck of the animal and less than a width of the head and a width of the shoulders of the animal such that the separation distance is selectively adjustable relative to a position of the headgate.

21. The spine extender of claim 2, wherein the restraint members are constrained to maintain a fixed angle of the longitudinal axis relative to a longitudinal axis of the headgate in both the extended mode and the collapsed mode.
